(19) United States
(12) Patent Application Publication
(10) Pub. No.: US 2015/0350593 A1
(43) Pub. Date: Dec. 3, 2015

(54) Moving Image Data Playback Apparatus Which Controls Moving Image Data Playback, And Imaging Apparatus

(71) Applicant: CASIO COMPUTER CO., LTD., Shibuya-ku (JP)

(72) Inventor: Hidetoshi ARAI, Kawagoe-shi (JP)

(21) Appl. No.: 14/636,963

(22) Filed: Mar. 3, 2015

(30) Foreign Application Priority Data
May 30, 2014 (JP) 2014-112126

(51) Int. Cl. H04N 7/01; H04N 5/77

(52) U.S. Cl. CPC H04N 7/0127; H04N 5/772

(57) ABSTRACT

A moving image data playback apparatus of the present invention includes a playback section which replays moving image data at a playback frame rate, and displays, when moving image data recorded at an imaging frame rate faster than the playback frame rate is replayed by the playback section, guidance information indicating a time elapsed in the recording which is different from a time elapsed in the playback of the moving image data.

### CROSS-REFERENCE TO RELATED APPLICATIONS

This application is based upon and claims the benefit of priority from the prior Japanese Patent Application No. 2014-112126, filed May 30, 2014, the entire contents of which are incorporated herein by reference.

### BACKGROUND OF THE INVENTION

1. Field of the Invention

The present invention relates to a moving image data playback apparatus which controls moving image data playback, and an imaging apparatus.

2. Description of the Related Art

A conventional technology for imaging apparatuses such as digital cameras is known in which an elapsed time in moving image capturing is recorded to be displayed in each frame image so that a viewer can check the time elapsed in the moving image recording (capturing) when he or she is replaying the moving image data (for example, Japanese Patent Application Laid-Open (Kokai) Publication No. Heisei 07-312738). Also, a technology is known in which an elapsed time in moving image recording (capturing) is not recorded on each frame image, but an elapsed time (clock time) in moving image recording is calculated based on the recording start time and information regarding the playback timing of each frame included in the moving image data, and displayed on each frame image by being superimposed thereon (for example, Japanese Patent Application Laid-Open (Kokai) Publication No. 2002-281455).

### SUMMARY OF THE INVENTION

In accordance with one aspect of the present invention, there is provided a moving image data playback apparatus comprising: a playback section which replays moving image data at a playback frame rate; and a guidance information display section which displays, when moving image data recorded at an imaging frame rate faster than the playback frame rate is replayed by the playback section, guidance information indicating a time elapsed in recording which is different from a time elapsed in playback of the moving image data.

In accordance with another aspect of the present invention, there is provided a moving image data playback method comprising: a playback step of replaying moving image data at a playback frame rate; and a guidance information display step of displaying, when moving image data recorded at an imaging frame rate faster than the playback frame rate is replayed in the playback step, guidance information indicating a time elapsed in recording which is different from a time elapsed in playback of the moving image data.

In accordance with another aspect of the present invention, there is provided a non-transitory computer-readable storage medium having a program stored thereon that is executable by a computer of a moving image data playback apparatus to actualize functions comprising: playback processing for replaying moving image data at a playback frame rate; and guidance information display processing for displaying, when moving image data recorded at an imaging frame rate faster than the playback frame rate is replayed in the playback processing, guidance information indicating a time elapsed in recording which is different from a time elapsed in playback of the moving image data.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing basic components of a digital camera in which the present invention has been applied as a moving image data playback apparatus;

FIG. 2A is a diagram showing an example of a monitor screen at the time of high-speed imaging;

FIG. 2B is a diagram showing an example of a replay screen showing a moving image captured by high-speed imaging;

FIG. 3 is a flowchart of moving image capture processing that is started when a moving image capturing mode is selected;

FIG. 4 is a flowchart of moving image playback processing that is started when a moving image playback mode is selected; and

FIG. 5 is a flowchart of operations of the moving image playback processing following those in FIG. 4.

### DETAILED DESCRIPTION OF THE PREFERRED EMBODIMENTS

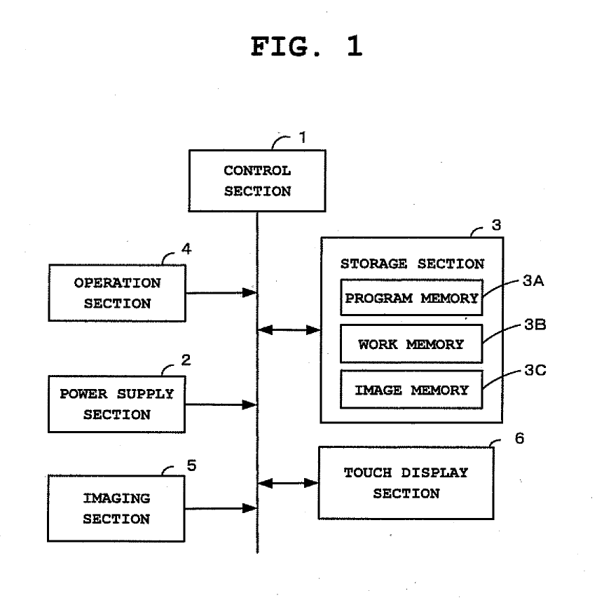

An embodiment of the present invention will hereinafter be described with reference to FIG. 1 to FIG. 5.

FIG. 1 is a block diagram showing basic components of a digital camera in which the present invention has been applied as a moving image data playback apparatus.

This digital camera is a compact camera having functions such as an imaging function (a still image capturing function, a moving image capturing function) by which photographic subjects can be captured with high definition, a clock function for keeping the current date and time or clocking a time set by a timer, and an image playback function for arbitrarily reading out and replaying a captured and recorded image (stored image). A characteristic function thereof is a high-speed imaging function by which high-speed imaging is performed at a frame rate faster (higher) than a frame rate in normal moving image capturing (such as 30 fps). In this high-speed imaging function, when an arbitrary frame rate is selected by a user operation from among frame rates of, for example, “120 fps”, “240 fps”, “480 fps”, and “1000 fps”, high-speed imaging is performed at this selected frame rate.

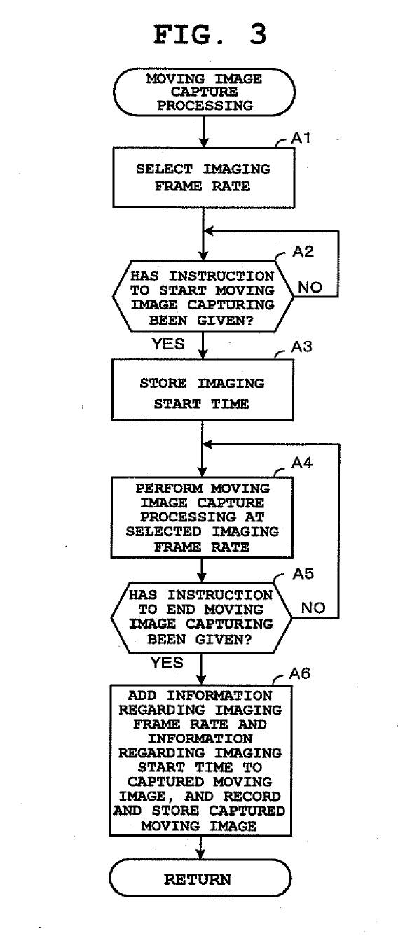

A control section 1 in FIG. 1 operates by electric power supplied from a power supply section (secondary battery) 2, and controls the overall operation of the digital camera in accordance with various programs stored in a storage section 3. This control section 1 is provided with a CPU (Central Processing Unit) and a memory not shown. The storage section 3 is structured to include a ROM (Read Only Memory) and a flash memory, and has a program memory 3A which stores programs and various applications to achieve the present embodiment according to the operational procedures shown in FIG. 3 to FIG. 5 described below, a work memory 3B which temporarily stores flags or the like, and an image memory 3C for compressing, recording, and storing captured images. Note that the storage section 3 may be structured to include a detachable portable memory (recording media) such as an SD (Secure Digital) card or an IC (Integrated Circuit) card. Although not illustrated, in a case where the storage section 3 is connected to a network by a communication function, the storage section 3 may include a storage area on the side of a predetermined server apparatus.

An operation section 4 in FIG. 1 includes various press-button type keys, such as a mode change key for switching between an operation mode for capturing images (imaging mode) and an operation mode for replaying captured (stored) images (replay mode) or between a still image capturing mode and a moving image capturing mode of the imaging mode, a moving image capturing start/end key for instructing to start or end moving image capturing, a moving image playback start/end key for instructing to start or end moving image playback, and a setting key for setting imaging conditions such as exposure, shutter speed, etc. The control section 1 performs processing, such as mode change processing, image capture processing, and imaging condition setting processing, in accordance with an input operation signal sent from the operation section 4.

An imaging section 5 in FIG. 1, which can capture a photographic subject with high definition by a subject image from an optical lens being formed on an image sensor such as a CCD (Charge-Coupled Device) or CMOS (Complementary Metal Oxide Semiconductor) omitted in the drawings, includes an imaging lens, the image sensor, a stroboscope, various types of sensors, an analog processing section, and a digital processing section. Images captured by this imaging section 5 are subjected to image compression processing, and recorded and stored in the image memory 3C such as a SD card. A touch display section 6 in FIG. 1 is structured by a transparent, touch panel being laminated on a display screen such as a high-definition liquid crystal, on which various types of software keys (touch keys) are allocated and arranged. This touch display section 6 displays function names, or senses a touch operation performed by a finger or the like and inputs an operation signal based on the touch operation. The display screen of the touch display section 6 serves as a monitor screen (live view screen) for displaying an image being captured (live view image) in real time and a replay screen for replaying a captured image.

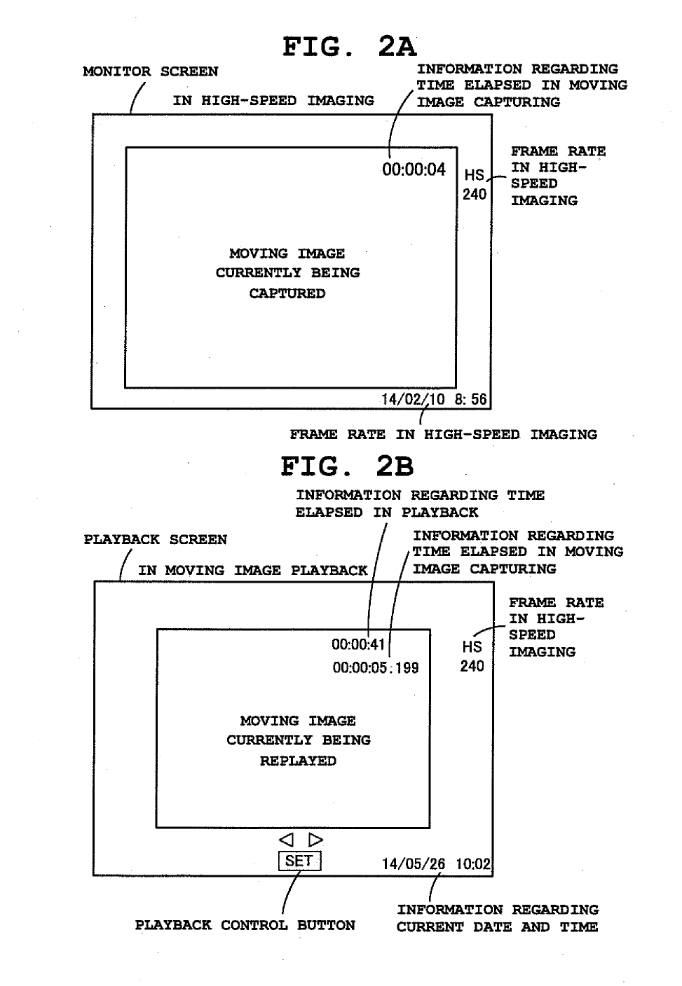

FIG. 2A is a diagram showing an example of the monitor screen at the time of high-speed imaging, and FIG. 2B is a diagram showing an example of the replay screen displaying a moving image captured by high-speed imaging.

On the monitor screen at the time of high-speed imaging, images being captured (frame images that constitute moving image data) are sequentially displayed, as shown in FIG. 2A. In addition, information regarding a time elapsed in the moving image recording (image capturing) is displayed by being superimposed on a corner portion (an upper right corner portion in the example of FIG. 2A) of the monitor screen displaying images being captured (frame images). This information regarding a time elapsed in the moving image recording is guidance information indicating a time elapsed from the start of the high-speed imaging, which is represented in hours, minutes, and seconds. The description “00:00:04” in the example of FIG. 2A indicates timing where four seconds have elapsed since the start of the moving image recording. Also on the monitor screen, an imaging frame rate arbitrarily selected by a user operation in the high-speed imaging is displayed. In the example of FIG. 2A, “HS (high speed) 240 (240 fps)” has been displayed as this guidance information. Moreover, information regarding the current year, month, day, and time is displayed on this monitor screen. In the example of FIG. 2A, “14/02/10 8:56” has been displayed as this guidance information.

In this embodiment, when a moving image captured by high-speed imaging is to be replayed, a frame rate that is different from a frame rate (imaging frame rate) used in the image capturing can be arbitrarily selected as a frame rate for the playback (playback frame rate) by a user operation. For example, when a playback frame rate (for example, 30 fps or 60 fps) that is slower (lower) than an imaging frame rate (“120 fps”, “240 fps”, “480 fps”, or “1000 fps”) is specified (a default playback frame rate of 30 fps is selected when the user does not specify any frame rate), that is, when an imaging frame rate is faster than a playback frame rate, each frame image constituting moving image data acquired by the high-speed imaging is replayed by slow-motion playback according to the selected playback frame rate. Here, in the playback of the moving image data, the moving image data is displayed on the playback screen in a display size corresponding to a predetermined imaging frame rate (such as “120 fps”, “240 fps”, “480 fps”, or “1000 fps”). For example, when the imaging frame rate is “120 fps”, the moving image data is replayed in a display size of 640×480 dots. When the imaging frame rate is “240 fps”, the moving image data is replayed in a display size of 512×384 dots.

As shown in FIG. 2B, on the playback screen displaying a moving image captured by high-speed imaging, images being replayed (frame images constituting the moving image data) are sequentially displayed. In addition, information regarding a time elapsed in the moving image playback is displayed by being superimposed on a corner portion (an upper right corner portion in the example of FIG. 2B) of the playback screen displaying images being replayed (frame images). This information regarding a time elapsed in the moving image playback is guidance information indicating a time elapsed from the start of the moving image playback, which is represented in hours, minutes, and seconds. The description “00:00:41” in the example of FIG. 2B indicates timing where forty-one seconds have elapsed since the start of the moving image playback. In an area near the information regarding a time elapsed in the moving image playback, information regarding a time elapsed in the moving image recording is displayed in parallel by being superimposed thereon.

This information on the playback screen regarding a time elapsed in the moving image recording is guidance information indicating a time elapsed from the start of the high-speed imaging during the high-speed imaging, which is represented in hours, minutes, seconds, and milliseconds. The description “00:00:05.199” in the example of FIG. 2B indicates timing where 5 seconds and 199 milliseconds have elapsed since the start of the imaging, which corresponds to the imaging timing of a frame image currently being replayed. This information regarding a time elapsed in the moving image capturing is calculated corresponding to a frame image currently being displayed every time one of the frame images constituting the moving image data captured by the high-speed imaging is replayed in sequence, and then displayed with the frame image currently being displayed. Also, on the playback screen displaying the moving image data, an imaging frame rate arbitrarily selected by a user operation in the high-speed imaging is displayed. In the example of FIG. 2B, “HS (high speed) 240 (240 fps)” has been displayed as this guidance information. Moreover, information regarding the current year, month, day, and time is displayed on this playback screen. In the example of FIG. 25, “14/05/26 10:02” has been displayed as this guidance information.

Furthermore, on the playback screen displaying the moving image data, a playback control button (touch key) SET is provided, which is used to instruct to perform fast-forward playback or rewind playback, or to pause playback. By this playback control button SET, for example, “fast-forward playback”, “rewind playback”, and “pause” can be specified in turn every time a tap operation is performed. Also, every time a double-tap operation is performed with “fast-forward playback” or “rewind playback” being specified, the speed of “fast-forward playback (or slow playback)” or “rewind playback” can be increased in stages.

When the playback of the moving image data is paused, the change of the time elapsed in the moving image recording and the change of the time elapsed in the moving image playback are temporarily stopped. That is, even when the playback speed is changed by pausing or fast forwarding during the playback of the moving image data, an elapsed time to be calculated and displayed for the same frame does not change.

Also, when the playback of the moving image data is being paused, the frame-by-frame playback of playback frames can be performed in accordance with a user operation. In this case, the time elapsed in the moving image recording is changed for each frame in units of milliseconds, and the time elapsed in the moving image playback is changed for each group of plural frames in units of seconds.

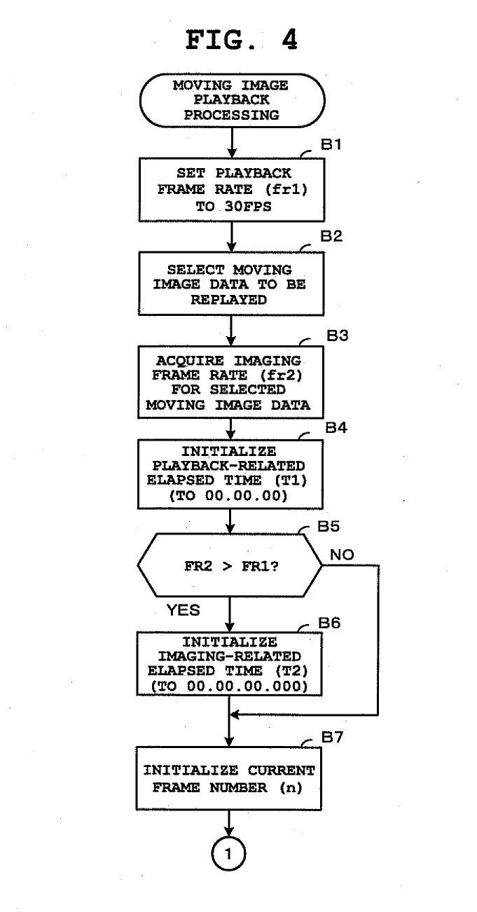

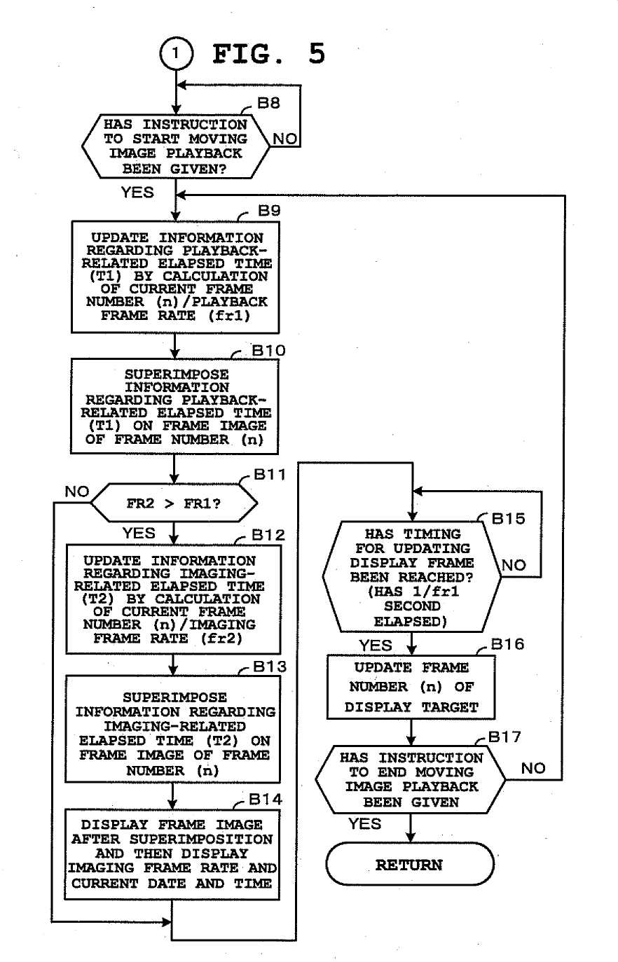

Next, an operational concept of the digital camera in the present embodiment is described with reference to flowcharts shown in FIG. 3 to FIG. 5. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. Note that these flowcharts in FIG. 3 to FIG. 5 outline operations of the characteristic portion of the present embodiment from among all of the operations of the digital camera. After exiting the flow in FIG. 3 or the flow in FIG. 4 and FIG. 5, the procedure returns to the main flow (not shown) of the overall operation.

FIG. 3 is a flowchart of moving image capture processing that is started when a moving image capturing mode is selected.

First, the control section 1 displays a list of selection candidates for a frame rate for high-speed imaging, such as “30 fps”, “60 fps”, “120 fps”, “240 fps”, “480 fps”, and “1000 fps”. Then, when an arbitrary frame rate is selected from the list screen by a user operation, the control section 1 determines the selected frame rate as an imaging frame rate (Step A1), and enters a wait state so as to wait for an operation of pressing a moving image capturing start/end button for instructing to start moving image capturing (Step A2).

Then, when the moving image capturing start/end button is operated to instruct to start moving image capturing (YES at Step A2), the control section 1 acquires the current date and time as an imaging start date and time by use of the above-described clock function, and temporarily stores it in the work memory 3B (Step A3). Subsequently, the control section 1 performs moving image capture processing at the selected frame rate (imaging frame rate) (Step A4). Here, when a frame rate of “120 fps”, “240 fps”, “480 fps”, or “1000 fps” has been selected, the control section 1 performs high-speed imaging at this imaging frame rate.

Next, the control section 1 judges whether the moving image capturing start/end button has been operated again to instruct to end the moving image capturing (Step A5), and continues the moving image capture processing until an instruction to end the moving image capturing is given (Step A4). When an instruction to end the moving image capturing is given (YES at Step A5), the control section 1 records and stores captured moving image data (frame images) as a moving image file. In addition, the control section 1 reads out and acquires information regarding the selected frame rate (imaging frame rate) and information regarding the imaging start date and time, and adds them to the header portion of the moving image file. Then, the control section 1 records and stores the moving image file in the image memory 3C such as an SD card (Step A6), and exits the flow of FIG. 3.

FIG. 4 and FIG. 5 are flowcharts of moving image playback processing that is started when a moving image playback mode is selected.

First, the control section 1 sets a playback frame rate for replaying moving image data (fr1) to “30 fps” (Step B1 of FIG. 4). Note that, in a case where an arbitrary playback frame rate has been selected by a user operation, the selected frame rate is set as the playback frame rate. However, here, the default frame rate of “30 fps” is set as described above. Then, the control section 1 displays a list of moving image data files (for example, a list of their titles) stored in the image memory 3C as selection candidates. When arbitrary moving image data is selected from the list by a user operation, the control section 1 determines the selected moving image data as a playback target (Step B2), and reads out and acquires an imaging frame rate (fr2) for the moving image data selected as a playback candidate, from the header portion of the moving image file (Step B3). Subsequently, the control section 1 performs processing for initializing (to 00.00.00) a playback-related elapsed time (T1) (Step B4).

Next, the control section 1 compares the playback frame rate (fr1) with the imaging frame rate (fr2), and thereby judges whether a condition of “fr2>fr1” has been satisfied, or in other words, judges whether the imaging frame rate is faster than the playback frame rate (Step B5). When judged that a condition of “fr2>fr1” has been satisfied (YES at Step B5), the control section 1 performs processing for initializing (to 00.00.00.000) an imaging-related elapsed time (T2) (Step B6). Note that, when fr2 is equal to fr1 (fr2=fr1) or when fr2 is smaller than fr1 (fr2<fr1) (NO at Step B5), the processing for initializing the imaging-related elapsed time (T2) (Step B6) is skipped.

Next, the control section 1 performs processing for initializing (to 1) the current frame number (n) so as to sequentially specify display target frame images from frame images constituting the moving image data (Step 137). Subsequently, the control section 1 proceeds to the flow of FIG. 5, and enters a wait state so as to wait for an operation of pressing a moving image playback start/end button for instructing to start moving image playback (Step B8). When the moving image playback start/end button is operated and an instruction to start moving image playback is given (YES at Step B8), the control section 1 performs processing for updating information regarding a playback-related elapsed time (T1) by the calculation of the current frame number (n)/the playback frame rate (fr1) (Step 19). As a result, first, “T1=1/30 seconds” is acquired. Next, the control section 1 performs processing for reading out a frame image specified by the current frame number (n) and superimposing the information regarding the playback-related elapsed time (T1) on a portion of the frame image (Step B10). Then, the control section 1 compares the playback frame rate (fr1) with the imaging frame rate (fr2) and thereby judges whether a condition of “fr2>fr1” has been satisfied (Step B11).

When judged that the imaging frame rate is faster than the playback frame rate and therefore a condition of “fr2>fr1” has been satisfied (YES at Step Ell), the control section 1 performs processing for updating information regarding the imaging-related elapsed time (T2) by the calculation of the current frame number (n)/the imaging frame rate (fr2) (Step B12). Here, if the imaging frame rate (fr2) is “120 fps”, “T1=1/120 seconds” is acquired at first. Then, the control section 1 performs processing for superimposing the information regarding the imaging-related elapsed time (T2) on a portion of the frame image specified by the current frame number (n) (Step B13). Note that, when fr2 is equal to fr1 (fr2=fr1) or when fr2 is smaller than fr1 (fr2<fr1) (NO at Step B11), the update processing (Step B12) and the superimposition processing (Step B13) are skipped.

Subsequently, the control section 1 displays the frame image after the superimposition on the playback screen of the touch display section 6, and then displays the imaging frame rate and the current date and time as guidance information (Step B14). Here, when fr2 is equal to fr1 (fr2=fr1) or when fr2 is smaller than fr1 (fr2<fr1) (NO at Step B11), the playback-related elapsed time (T1), the imaging frame rate, and the current date and time are displayed on the frame image as guidance information. When fr2 is larger than fr1 (fr2>fr1) (YES at Step B11), the information regarding the imaging-related elapsed time (T2) is also displayed as the guidance information.

Next, the control section 1 judges whether timing to update the displayed frame has been reached, or in other words, judges whether 1/fr1 second (1/30 second) has elapsed (Step 315), and enters a wait state until the update timing is reached. When the update timing is reached (YES at Step B15), the control section 1 performs processing for updating the current frame number (n) for specifying a display target frame image by adding “1” to the value of the frame number (n) (Step 316). As a result of this configuration, a current frame number (n) is updated every 1/30 second. Note that the update timing is not limited to 1/30 second and, for example, a configuration may be adopted in which a current frame number (n) is updated every 1/10 second or 1/20 second even when the playback frame rate (fr1) is “30 fps” Then, the control section 1 judges again whether an instruction to end the moving image playback has been given by an operation of pressing the moving image playback start/end button (Step 317), and returns to Step 89 when an instruction to end the moving image playback has not been given. Hereafter, the control section 1 repeats the above-described operations until an instruction to end the moving image playback is given. Then, when an instruction to end the moving image playback is given, the control section 1 exits the flows of FIG. 4 and FIG. 5 (YES at Step B17).

As described above, when replaying moving image data recorded at an imaging frame rate different from a specified playback frame rate, the control section 1 of the present embodiment sequentially replays frame images constituting the moving image data at a speed corresponding to the playback frame rate. During the playback, the control section 1 calculates, for a frame image being displayed, information regarding a time elapsed in the moving image recording based on the imaging frame rate, and displays this information regarding the time elapsed in the moving image recording as guidance information, together with the frame image being displayed. As a result of this configuration, the viewer can view a moving image while properly checking a time elapsed in the moving image recording, and thereby can give an instruction to, for example, pause the playback operation or perform fast-forward playback at timing at which a predetermined time (such as five seconds) has elapsed from the start of the image capturing in the moving image being replayed. In this case, even when the viewer performs fast-forward playback or rewind playback, information regarding a time elapsed in the moving image recording indicates timing at which a frame image being replayed has been captured.

Also, the control section 1 calculates, for each frame image being replayed, information regarding a time elapsed in the playback based on the playback frame rate, and displays this information regarding a time elapsed in the playback as guidance information, together with the frame image being replayed. As a result of this configuration, the viewer can check information regarding a time elapsed in playback in addition to information regarding a time elapsed in moving image capturing.

Moreover, the control section 1 controls whether or not to display information regarding a time elapsed in moving image capturing together with a frame image being replayed, based on a predetermined condition. As a result of this configuration, information regarding a time elapsed in moving image recording can be provided as necessary.

Furthermore, the control section 1 displays information regarding a time elapsed in moving image capturing together with a frame image being replayed, on condition that the imaging frame rate differs from the playback frame rate. As a result of this configuration, information regarding a time elapsed in moving image recording can be provided based on a relation between a playback frame rate and the imaging frame rate.

Still further, the control section 1 displays information regarding a time elapsed in moving image capturing together with a frame image being replayed, on condition that the imaging frame rate is faster than the playback frame rate. As a result of this configuration, information regarding a time elapsed in moving image recording can be provided when a playback frame rate is slower than the imaging frame rate.

Yet still further, the control section 1 displays information regarding a time elapsed in moving image capturing together with a frame image being replayed, on condition that the moving image data is being replayed in a display size corresponding to a predetermined imaging frame rate. As a result of this configuration, information regarding a time elapsed in moving image capturing can be provided based on a display size corresponding to the imaging frame rate.

Yet still further, the control section 1 displays current date and time information calculated by the clock function, together with a frame image being replayed. As a result of this configuration, the viewer can check the current date and time that elapses without being temporarily stopped even when the playback of moving image data is paused, in addition to information regarding a time elapsed in the playback and information regarding a time elapsed in the moving image recording.

In the above-described embodiment, whether or not to display information regarding a time elapsed in moving image recording together with a frame image being replayed is controlled based on a predetermined condition. However, a configuration may be adopted in which whether or not to display information regarding a time elapsed in playback together with a frame image being replayed is also controlled based on a predetermined condition. In this configuration, information regarding a time elapsed in playback can be provided as necessary. Note that this predetermined condition may be a condition arbitrarily specified by the user.

Also, in the above-described embodiment, the processing is performed in which information regarding a time elapsed in moving image capturing (T2) is updated by the calculation of a current frame number (n)/an imaging frame rate (fr2). However, this calculation method can be arbitrarily determined. For example, a value acquired by a measurement counter that performs, when an imaging frame rate is “240 fps” and a playback frame rate is “30 fps”, a counting operation at a speed of 30/240-fold with respect to an elapsed time in moving image playback may be acquired as information regarding a time elapsed in moving image recording.

Moreover, in the above-described embodiment, a time elapsed from the start of moving image capturing has been described as information regarding a time elapsed in the moving image recording. However, it may be a clock time elapsed since the start of the moving image capturing. In this configuration, when starting the playback of moving image data, the control section 1 reads out an imaging start clock time added to the moving image data in the moving image capturing (refer to Step A6 in FIG. 3). Then, the control section 1 calculates a clock time elapsed from the start of the image capturing in the moving image data by adding a time elapsed in the moving image recording to the imaging start clock time, and displays this clock time with a frame image being replayed. For example, when the imaging start clock time is “05:00:00 a.m. on Feb. 10, 2014”, “2014.02.10.05:00:00:000” is displayed at the start of the playback by guidance display, as information regarding a time elapsed in the moving image recording. Then, at a time point when five seconds have elapsed since the start of the playback, “2014.02.10.05:00:05:000” is displayed by guidance display. As a result of this configuration, when the viewer is viewing, for example, a moving image showing the moment of sunrise, the actual sunrise time (capturing date and time) can be provided.

Also, the information regarding a time elapsed in moving image recording is not necessarily required to be displayed by numerical string data, and the display of a time elapsed in moving image recording may be performed by a graph or a level being displayed. In addition, the information regarding a time elapsed in playback is not necessarily required to be an elapsed time, and may be a clock time from when playback is started. This information is also not necessarily required to be displayed by numerical string data, and may be displayed by graph display or level display.

Also, in the above-described embodiment, information regarding a time elapsed in moving image recording and information regarding a time elapsed in playback are displayed by being superimposed on a frame image being replayed. However, this image superimposition processing is not necessarily required to be performed, and a configuration may be adopted in which information regarding a time elapsed in moving image recording and information regarding a time elapsed in playback are displayed as guidance information in an area around a frame image being displayed.

Moreover, in the above-described embodiment, the case has been exemplarily described in which an imaging frame rate is faster than a playback frame rate, or in other words, slow-motion playback is performed for moving image data acquired by high-speed imaging. However, the present invention is not limited to be applied to the case where moving image data acquired by high-speed imaging is replayed. For example, the present invention may be applied to a case where moving image data acquired by interval shooting or slow-speed imaging and showing scudding clouds or a blooming flower is replayed by fast-forward playback. In a configuration for this case, information regarding a time elapsed in moving image recording (an elapsed time calculated based on the imaging frame rate) and information regarding a time elapsed in playback (an elapsed time calculated based on the playback frame rate) are displayed with a frame image being displayed even when moving image data captured at a frame rate of “1/10 fps”, “1fps”, “10 fps” is replayed at a frame rate of “30 fps”.

Furthermore, in the above-described embodiment, the present invention has been applied to a digital camera as a moving image data playback apparatus. However, the present invention is not limited thereto, and may be applied to a camera-function-equipped personal computer, a PDA (Personal Digital Assistant), a portable telephone such as a smartphone, a tablet terminal, a music player, or a DVD (Digital Versatile Disc) player.

Still further, the “apparatus” or the “sections” described in the above-described embodiment are not required to be in a single housing and may be separated into a plurality of housings by function. In addition, the steps in the above-described flowcharts are not required to be processed in time-series, and may be processed in parallel, or individually and independently.

Yet still further, in the above-described embodiment, the control section 1 is operated based on the programs stored in the storage section 3, whereby various types of functions (processing or sections) required to achieve the various types of effects described above are partially or entirely actualized (performed or configured). However, this is merely an example and other various methods can be used to actualize these functions.

For example, these various functions may be partially or entirely actualized by an electronic circuit, such as an IC (Input Circuit) or a LSI (Large-Scale Integration). Note that specific examples of the configuration of this electronic circuit are not described herein because a person ordinarily skilled in the art of the invention can easily actualize this configuration based on the flowcharts and the functional block diagrams described in the specification (For example, judgment processing accompanied by branch processing in the flowcharts can be configured by input date being compared by a comparator and a selector being switched by the comparison result).

Also, the plural functions (processing or sections) required to achieve the various effects can be freely divided. The following are examples thereof.

(Configuration 1)

A configuration including a playback section which replays moving image data at a playback frame rate; and a guidance information display section which displays, when moving image data recorded at an imaging frame rate faster than the playback frame rate is replayed by the playback section, guidance information indicating a time elapsed in recording which is different from a time elapsed in playback of the moving image data.

(Configuration 2)

The above-described configuration 1, in which the guidance information display section displays the time elapsed in the playback of the moving image data currently being replayed by the playback section and the time elapsed in the recording, in display manners different from each other.

(Configuration 3)

The above-described configuration 1, in which the guidance information display section displays the time elapsed when the moving image data recorded at the imaging frame rate faster than the playback frame rate is being replayed by the playback section and a time elapsed when moving image data recorded at an imaging frame rate equal to or slower than the playback frame rate is being replayed, in display manners different from each other.

(Configuration 4)

The above-described configuration 1, in which the guidance information display section displays, when displaying the guidance information indicating the time elapsed in the recording of the moving image data recorded at the imaging frame rate faster than the playback frame rate, the elapsed time using a larger number of digits than when guidance information indicating the time elapsed in the playback of the moving image data is displayed or when guidance information indicating an elapsed time for moving image data recorded at an imaging frame rate equal to or slower than the playback frame rate is displayed.

(Configuration 5)

The above-described configuration 4, in which the guidance information display section displays, when displaying the guidance information indicating the time elapsed in the recording of the moving image data recorded at the imaging frame rate faster than the playback frame rate, the time using a larger number of digits than when guidance information indicating the time elapsed in the playback of the moving image data recorded at the imaging frame rate faster than the playback frame rate is displayed or when guidance information indicating a time elapsed in recording of the moving image data recorded at the imaging frame rate equal to or slower than the playback frame rate is displayed.

(Configuration 6)

The above-described configuration 1, further including: a first calculation section which calculates, for each frame image being replayed by the playback section, the time elapsed in the recording of the moving image data based on the imaging frame rate, in which the guidance information display section displays guidance information indicating the elapsed time calculated by the first calculation section when the playback section replays each frame image constituting the moving image data.

(Configuration 7)

The above-described configuration 6, further including: a second calculation section which calculates, for each frame image being replayed by the playback section, the time elapsed in the playback of the moving image data based on the playback frame rate, in which the guidance information display section displays guidance information indicating the elapsed time calculated by the second calculation section when the playback section replays each frame image constituting the moving image data.

(Configuration 8)

The above-described configuration 6, in which the guidance information display section controls whether or not to display the guidance information indicating the time elapsed in the recording calculated by the first calculation section together with the frame image being replayed, based on a predetermined condition.

(Configuration 9)

The above-described configuration 8, in which the guidance information display section displays the guidance information indicating the time elapsed in the recording calculated by the first calculation section together with the frame image being replayed, on condition that the imaging frame rate is different from the playback frame rate.

(Configuration 10)

The above-described configuration 9, in which the guidance information display section displays the guidance information indicating the time elapsed in the recording calculated by the first calculation section together with the frame image being replayed, on condition that the imaging frame rate is faster than the playback frame rate.

(Configuration 11)

The above-described configuration 8, in which the guidance information display section displays the guidance information indicating the time elapsed in the recording calculated by the first calculation section together with the frame image being replayed, on condition that the moving image data is replayed in a display size corresponding to a predetermined imaging frame rate.

(Configuration 12)

The above-described configuration 7, in which the guidance information display section displays the guidance information indicating the time elapsed in the recording calculated by the first calculation section and the guidance information indicating the time elapsed in the playback calculated by the second calculation section simultaneously, together with the frame image being replayed.

(Configuration 13)

The above-described configuration 1, in which the guidance information display section displays a different elapsed time for each frame, in the guidance information indicating the time elapsed in the recording, and displays a different elapsed time for each group of plural frames, in guidance information indicating the time elapsed in the playback.

(Configuration 14)

The above-described configuration 13, in which the guidance information display section changes and displays the elapsed time in units of time equal to or less than one-tenth of a second, in the guidance information indicating the time elapsed in the recording, and displays the elapsed time in units of time equal to or more than one second, in the guidance information indicating the time elapsed in the playback.

(Configuration 15)

The above-described configuration 7, further including: a playback speed control section which pauses the playback of the moving image data by the playback section, in which the guidance information display section temporarily stops changes of the time elapsed in the recording and changes of the time elapsed in the playback when the playback is paused by the playback speed control section.

(Configuration 16)

The above-described configuration 15, further including: a clock section which calculates clock time information, in which the guidance information display section displays the clock time information calculated by the clock section together with the frame image being replayed without temporarily stopping elapse of a clock time even when the playback is paused by the playback speed control section.

(Configuration 17)

The above-described configuration 1, further including: an image capturing section which captures a moving image at an imaging frame rate faster than a playback frame rate, and acquires moving image data.

While the present invention has been described with reference to the preferred embodiments, it is intended that the invention be not limited by any of the details of the description therein but includes all the embodiments which fall within the scope of the appended claims.

What is claimed is:

1. A moving image data playback apparatus comprising:
a playback section which replays moving image data at a playback frame rate; and
a guidance information display section which displays, when moving image data recorded at an imaging frame rate faster than the playback frame rate is replayed by the playback section, guidance information indicating a time elapsed in recording which is different from a time elapsed in playback of the moving image data.

2. The moving image data playback apparatus according to claim 1, wherein the guidance information display section displays the time elapsed in the playback of the moving image data currently being replayed by the playback section and the time elapsed in the recording, in display manners different from each other.

3. The moving image data playback apparatus according to claim 1, wherein the guidance information display section displays the time elapsed when the moving image data recorded at the imaging frame rate faster than the playback frame rate is being replayed by the playback section and a time elapsed when moving image data recorded at an imaging frame rate equal to or slower than the playback frame rate is being replayed, in display manners different from each other.

4. The moving image data playback apparatus according to claim 1, wherein the guidance information display section displays, when displaying the guidance information indicating the time elapsed in the recording of the moving image data recorded at the imaging frame rate faster than the playback frame rate, the elapsed time using a larger number of digits than when guidance information indicating the time elapsed in the playback of the moving image data is displayed or when guidance information indicating an elapsed time for moving image data recorded at an imaging frame rate equal to or slower than the playback frame rate is displayed.

5. The moving image data playback apparatus according to claim 4, wherein the guidance information display section displays, when displaying the guidance information indicating the time elapsed in the recording of the moving image data recorded at the imaging frame rate faster than the playback frame rate, the time using a larger number of digits than when the guidance information indicating the time elapsed in the playback of the moving image data recorded at the imaging frame rate faster than the playback frame rate is displayed or when guidance information indicating a time elapsed in recording of the moving image data recorded at the imaging frame rate equal to or slower than the playback frame rate is displayed.

6. The moving image data playback apparatus according to claim 1, further comprising:
a first calculation section which calculates, for each frame image being replayed by the playback section, the time elapsed in the recording of the moving image data based on the imaging frame rate,
wherein the guidance information display section displays guidance information indicating the elapsed time calculated by the first calculation section when the playback section replays each frame image constituting the moving image data.

7. The moving image data playback apparatus according to claim 6, further comprising:
a second calculation section which calculates, for each frame image being replayed by the playback section, the time elapsed in the playback of the moving image data based on the playback frame rate,
wherein the guidance information display section displays guidance information indicating the elapsed time calculated by the second calculation section when the playback section replays each frame image constituting the moving image data.

8. The moving image data playback apparatus according to claim 6, wherein the guidance information display section controls whether or not to display the guidance information indicating the time elapsed in the recording calculated by the first calculation section together with the frame image being replayed, based on a predetermined condition.

9. The moving image data playback apparatus according to claim B, wherein the guidance information display section displays the guidance information indicating the time elapsed in the recording calculated by the first calculation section together with the frame image being replayed, on condition that the imaging frame rate is different from the playback frame rate.

10. The moving image data playback apparatus according to claim 9, wherein the guidance information display section displays the guidance information indicating the time elapsed in the recording calculated by the first calculation section together with the frame image being replayed, on condition that the imaging frame rate is faster than the playback frame rate.

11. The moving image data playback apparatus according to claim 8, wherein the guidance information display section displays the guidance information indicating the time elapsed in the recording calculated by the first calculation section together with the frame image being replayed, on condition that the moving image data is replayed in a display size corresponding to a predetermined imaging frame rate.

12. The moving image data playback apparatus according to claim 7, wherein the guidance information display section displays the guidance information indicating the time elapsed in the recording calculated by the first calculation section and the guidance information indicating the time elapsed in the playback calculated by the second calculation section simultaneously, together with the frame image being replayed.

13. The moving image data playback apparatus according to claim 1, wherein the guidance information display section displays a different elapsed time for each frame, in the guidance information indicating the time elapsed in the recording, and displays a different elapsed time for each group of plural frames, in guidance information indicating the time elapsed in the playback.

14. The moving image data playback apparatus according to claim 13, wherein the guidance information display section changes and displays the elapsed time in units of time equal to or less than one-tenth of a second, in the guidance information indicating the time elapsed in the recording, and changes and displays the elapsed time in units of time equal to or more than one second, in the guidance information indicating the time elapsed in the playback.

15. The moving image data playback apparatus according to claim 7, further comprising:
a playback speed control section which pauses the playback of the moving image data by the playback section,
wherein the guidance information display section temporarily stops changes of the time elapsed in the recording and changes of the time elapsed in the playback when the playback is paused by the playback speed control section.

16. The moving image data playback apparatus according to claim 15, further comprising:
a clock section which calculates clock time information,
wherein the guidance information display section displays the clock time information calculated by the clock section together with the frame image being replayed, without temporarily stopping elapse of a clock time even when the playback is paused by the playback speed control section.

17. An imaging apparatus comprising:
an image capturing section which captures a moving image at an imaging frame rate faster than a playback frame rate, and acquires moving image data;
a playback section which replays the moving image data at the playback frame rate; and
a guidance information display section which displays, when the moving image data recorded at the imaging frame rate faster than the playback frame rate is replayed by the playback section, guidance information indicating a time elapsed in recording which is different from a time elapsed in playback of the moving image data.

18. A moving image data playback method comprising:
a playback step of replaying moving image data at a playback frame rate; and
a guidance information display step of displaying, when moving image data recorded at an imaging frame rate faster than the playback frame rate is replayed in the playback step, guidance information indicating a time elapsed in recording which is different from a time elapsed in playback of the moving image data.

19. A non-transitory computer-readable storage medium having a program stored thereon that is executable by a computer of a moving image data playback apparatus to actualize functions comprising:
playback processing for replaying moving image data at a playback frame rate; and
guidance information display processing for displaying, when moving image data recorded at an imaging frame rate faster than the playback frame rate is replayed in the playback processing, guidance information indicating a time elapsed in recording which is different from a time elapsed in playback of the moving image data.
